(19) United States
(12) Patent Application Publication
(10) Pub. No.: US 2024/0328811 A1
(43) Pub. Date: Oct. 3, 2024

(54) DISPLAY SYSTEM AND CONTROL METHOD

(71) Applicant: Panasonic Automotive Systems Co., Ltd., Kanagawa (JP)

(72) Inventors: Akira TANAKA, Osaka (JP); Toshiya MORI, Osaka (JP)

(73) Assignee: Panasonic Automotive Systems Co., Ltd., Kanagawa (JP)

(21) Appl. No.: 18/612,624

(22) Filed: Mar. 21, 2024

(30) Foreign Application Priority Data
Mar. 31, 2023 (JP) 2023-059079

(51) Int. Cl. G01C 21/36; B60K 35/23; G02B 27/01; G09G 3/00

(52) U.S. Cl. CPC G01C 21/365; B60K 35/23; G09G 3/001; B60K 2360/166; G02B 27/0101; G02B 2027/0141; G09G 2340/0492; G09G 2380/10

(57) ABSTRACT

A display system includes: a drawer that draws a display image for guiding a vehicle to a destination; a display that projects light representing the display image to a windshield of the vehicle, to display the display image as a virtual image through the windshield; and a vehicle direction estimator that estimates a direction of the vehicle. When a difference angle between a route direction at a current location of the vehicle on a route that is set for guiding the vehicle to the destination and the direction of the vehicle estimated is less than a threshold, the display displays the display image pointing in a first direction along the route as the virtual image. When the difference angle is greater than or equal to the threshold, the display displays the display image pointing in a second direction obtained by correcting the first direction as the virtual image.

### CROSS REFERENCE TO RELATED APPLICATION

The present application is based on and claims priority of Japanese Patent Application No. 2023-059079 filed on Mar. 31, 2023.

### FIELD

The present disclosure relates to a display system and a control method.

### BACKGROUND

A display system is known that displays a display image for guiding a vehicle to a destination as a virtual image through the windshield of the vehicle (see, for example, Patent Literature (PTL) 1). In this display system, the direction of the vehicle is estimated as the direction along the route on the navigation map for guiding the vehicle to the destination. The display image is controlled so as to point in the estimated direction of the vehicle (i.e. the direction along the route).

### CITATION LIST

### Patent Literature

PTL 1: Japanese Unexamined Patent Application Publication No. 2021-179445

### SUMMARY

The conventional display system described above can be improved upon.

In view of this, the present disclosure provides a display system and control method capable of improving upon the above related art.

A display system according to one aspect of the present disclosure is a display system used for a head-up display provided to a vehicle, the display system including: a drawer that draws a display image for guiding the vehicle to a destination; a display that projects light representing the display image to a display medium of the vehicle, to display the display image as a virtual image through the display medium; and an estimator that estimates a direction of the vehicle, wherein when a difference angle between a route direction at a current location of the vehicle on a route that is set for guiding the vehicle to the destination and the direction of the vehicle estimated is less than a threshold, the display displays the display image pointing in a first direction along the route as the virtual image, and when the difference angle is greater than or equal to the threshold, the display displays the display image pointing in a second direction obtained by correcting the first direction as the virtual image.

These general and specific aspects may be implemented using a system, a method, an integrated circuit, a computer program, or a computer-readable non-transitory recording medium such as compact disc-read only memory (CD-ROM), or any combination of systems, methods, integrated circuits, computer programs, and recording media.

A display system, etc. according to one aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating a vehicle on which a display system according to an embodiment is mounted.

FIG. 2 is a diagram illustrating the display area of the windshield where a display image is displayed by the display system according to the embodiment.

FIG. 3 is a schematic diagram illustrating the structure of the display system according to the embodiment.

FIG. 4 is a diagram illustrating an example of a display image according to the embodiment.

FIG. 5 is a block diagram illustrating the functional structure of a controller in the display system according to the embodiment.

FIG. 6 is a flowchart illustrating the flow of operation of the controller in the display system according to the embodiment.

FIG. 7 is a diagram for explaining a specific example of Step S104 in the flowchart in FIG. 6.

FIG. 8 is a diagram for explaining a specific example of Step S104 in the flowchart in FIG. 6.

FIG. 9 is a diagram for explaining a specific example of Step S104 in the flowchart in FIG. 6.

### DESCRIPTION OF EMBODIMENT

### Underlying Knowledge Forming Basis of the Present Disclosure

The present inventors have found the following problem with the technology described in the “Background” section.

With the conventional display system described above, the accuracy of the direction in which the display image points decreases in situations such as when the vehicle is changing lanes, when the vehicle is traveling on a crank-shaped road, and when the vehicle is approaching the exit of a curve.

In order to solve such a problem, a display system according to a first aspect of the present disclosure is a display system used for a head-up display provided to a vehicle, the display system including: a drawer that draws a display image for guiding the vehicle to a destination; a display that projects light representing the display image to a display medium of the vehicle, to display the display image as a virtual image through the display medium; and an estimator that estimates a direction of the vehicle, wherein when a difference angle between a route direction at a current location of the vehicle on a route that is set for guiding the vehicle to the destination and the direction of the vehicle estimated is less than a threshold, the display displays the display image pointing in a first direction along the route as the virtual image, and when the difference angle is greater than or equal to the threshold, the display displays the display image pointing in a second direction obtained by correcting the first direction as the virtual image.

According to this aspect, the display image pointing in the first direction along the route is displayed as a virtual image in the case where the difference angle is less than the threshold, and the display image pointing in the second direction obtained by correcting the first direction is displayed as a virtual image in the case where the difference angle is greater than or equal to the threshold. Thus, the accuracy of the direction in which the display image points can be enhanced in situations such as when the vehicle is changing lanes, when the vehicle is traveling on a crank-shaped road, and when the vehicle is approaching the exit of a curve.

For example, in a second aspect, in the display system according to the first aspect, the second direction may be obtained by correcting the first direction by an angle that results from subtracting a dead zone angle from the difference angle.

According to this aspect, the first direction can be accurately corrected to obtain the second direction by appropriately adjusting the dead zone angle depending on, for example, the traveling situation of the vehicle.

For example, in a third aspect, in the display system according to the second aspect, the dead zone angle may be determined to be larger when a total number of lanes on a road on which the vehicle is traveling is larger.

According to this aspect, the dead zone angle can be determined based on the number of lanes on the road.

For example, in a fourth aspect, in the display system according to the second aspect, the route may be a route on a navigation map, and the dead zone angle may be determined to be smaller when the navigation map has higher accuracy.

According to this aspect, the dead zone angle can be determined based on the accuracy of the navigation map.

For example, in a fifth aspect, in the display system according to any one of the first aspect to the fourth aspect, when the difference angle is greater than or equal to the threshold, the drawer may change a display state of the display image between before and after the first direction is corrected to the second direction.

According to this aspect, changing the display state of the display image allows the driver to recognize that the direction in which the display image points has been corrected.

For example, in a sixth aspect, in the display system according to any one of the first aspect to the fifth aspect, the route direction at the current location of the vehicle may be a direction of a tangent at a route point corresponding to the current location of the vehicle on the route, and the first direction may be a direction of a tangent at a route point located ahead of the current location of the vehicle on the route.

According to this aspect, the direction in which the display image points can be controlled easily.

A control method according to a seventh aspect of the present disclosure is a control method in a display system used for a head-up display provided to a vehicle, the control method including: (a) drawing a display image for guiding the vehicle to a destination; (b) projecting light representing the display image to a display medium of the vehicle, to display the display image as a virtual image through the display medium; and (c) estimating a direction of the vehicle, wherein in (b), when a difference angle between a route direction at a current location of the vehicle on a route that is set for guiding the vehicle to the destination and the direction of the vehicle estimated is less than a threshold, the display image pointing in a first direction along the route is displayed as the virtual image, and when the difference angle is greater than or equal to the threshold, the display image pointing in a second direction obtained by correcting the first direction is displayed as the virtual image.

According to this aspect, the accuracy of the direction in which the display image points can be enhanced in situations such as when the vehicle is changing lanes, when the vehicle is traveling on a crank-shaped road, and when the vehicle is approaching the exit of a curve, as with the display system according to the first aspect.

An embodiment will be described in detail below, with reference to the drawings.

The embodiment described below shows a general or specific example. The numerical values, shapes, materials, structural elements, the arrangement and connection of the structural elements, steps, the processing order of the steps etc. shown in the following embodiment are mere examples, and do not limit the scope of the present disclosure. Of the structural elements in the embodiment described below, the structural elements not recited in any one of the independent claims representing the broadest concepts are described as optional structural elements.

### Embodiment

### [1. Overview of Display System]

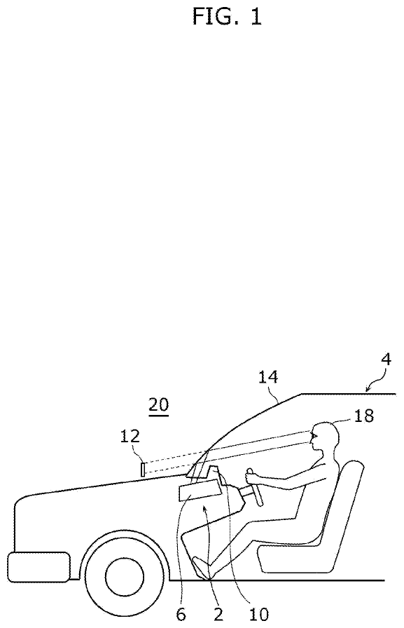

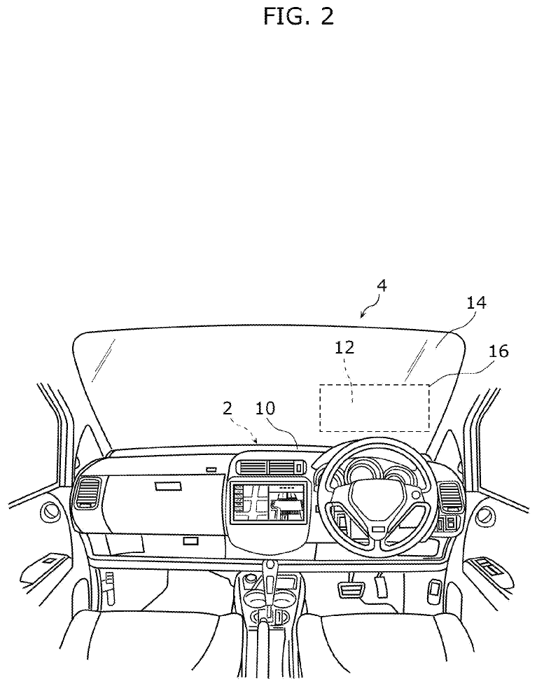

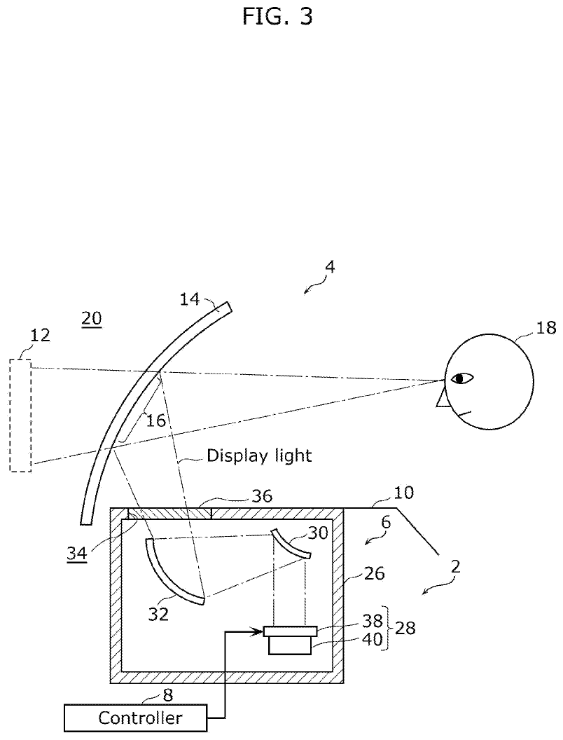

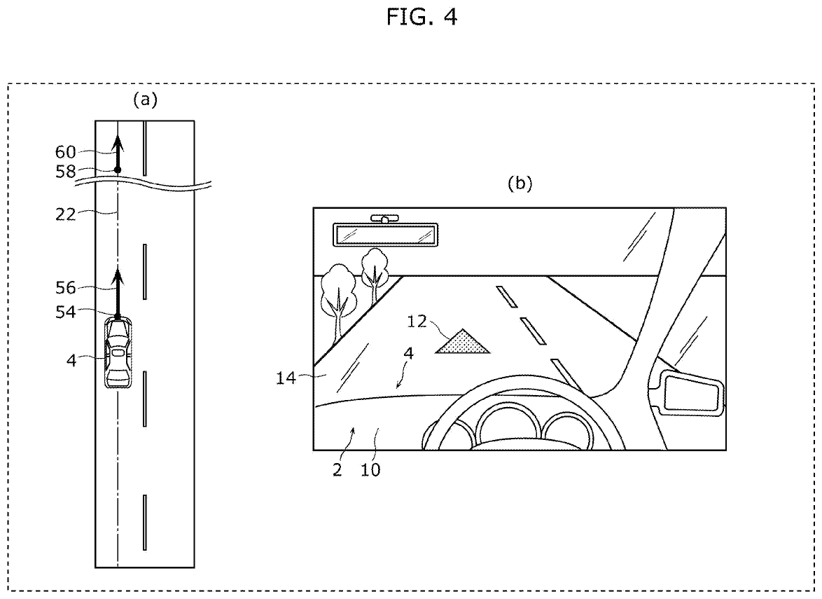

First, an overview of display system 2 according to an embodiment will be described with reference to FIGS. 1 to 4. FIG. 1 is a diagram illustrating vehicle 4 on which display system 2 according to the embodiment is mounted. FIG. 2 is a diagram illustrating display area 16 of windshield 14 where display image 12 is displayed by display system 2 according to the embodiment. FIG. 3 is a schematic diagram illustrating the structure of display system 2 according to the embodiment. FIG. 4 is a diagram illustrating an example of display image 12 according to the embodiment.

As illustrated in FIGS. 1 and 2, display system 2 according to the embodiment is mounted on (provided to) vehicle 4 such as an automobile. As illustrated in FIG. 3, display system 2 includes display 6 and controller 8.

Display 6 is a head-up display (HUD), and is located inside dashboard 10 of vehicle 4. As illustrated in FIGS. 1 to 3, display 6 projects display light for displaying display image 12 which is a virtual image to, for example, display area 16 closer to the driver's seat in windshield 14 (an example of a display medium) of vehicle 4, to cause the display light to reflect off display area 16 of windshield 14 toward driver 18. This enables driver 18 to see display image 12 as a virtual image in a state of being superimposed on the view ahead of windshield 14 through display area 16 of windshield 14. That is, display image 12 appears to driver 18 as if it were displayed in space 20 in front of windshield 14.

Display image 12 is an image for guiding vehicle 4 to a destination, and is, for example, an image representing a triangular arrow. When vehicle 4 is traveling along route 22 (designated by a dashed-dotted line) set on the navigation map to guide vehicle 4 to the destination as illustrated in (a) in FIG. 4, display image 12 points in the direction along route 22 as illustrated in (b) in FIG. 4. By seeing the direction in which display image 12 points, driver 18 can recognize route 22 to reach the destination. In FIG. 2, display image 12 is not illustrated for explanatory convenience.

As illustrated in FIG. 3, display 6 includes main housing 26, display unit 28, first mirror 30, and second mirror 32.

Main housing 26 is box-shaped, and is made of metal such as aluminum, for example. Main housing 26 is located inside dashboard 10 of vehicle 4. Display unit 28, first mirror 30, and second mirror 32 are arranged inside main housing 26. The upper surface of main housing 26 faces windshield 14. Opening 34 is formed in the upper surface of main housing 26. Opening 34 is covered with plate-shaped cover member 36 made of, for example, transparent resin.

Display unit 28 is a picture generation unit (PGU) that projects display light for displaying display image 12 to first mirror 30 and second mirror 32. Display unit 28 includes display panel 38 and backlight 40. Display panel 38 is, for example, a liquid crystal display (LCD), and displays display image 12 on the front display surface. Backlight 40 emits light toward the back surface of display panel 38.

First mirror 30 is, for example, a convex mirror, and reflects the display light from display unit 28 toward second mirror 32. Second mirror 32 is, for example, a concave mirror, and reflects the display light from first mirror 30 toward display area 16 of windshield 14. The display light from second mirror 32 is transmitted through cover member 36 and reflected off display area 16 of windshield 14, and then enters the eyes of driver 18.

Controller 8 controls display image 12 displayed by display 6. Specifically, controller 8 calculates the direction in which display image 12 is to point (hereafter referred to as “display direction”), and draws an image (an image that is the source of display image 12) to be displayed on display panel 38 of display unit 28 based on the calculated display direction. The functional structure of controller 8 will be described below.

### [2. Functional Structure of Controller]

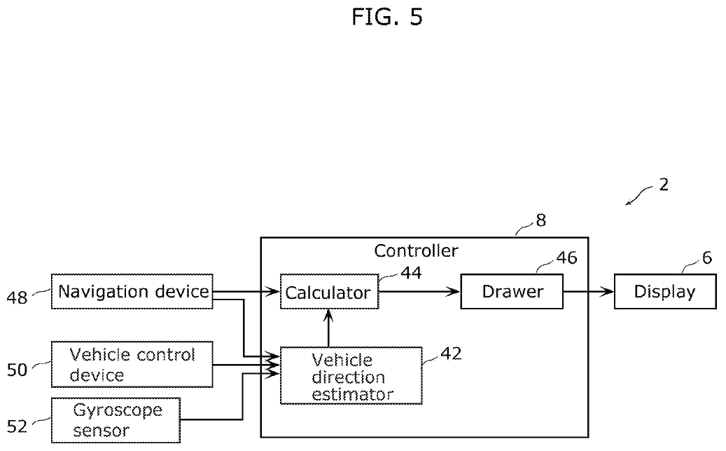

Next, the functional structure of controller 8 will be described with reference to FIGS. 4 and 5. FIG. 5 is a block diagram illustrating the functional structure of controller 8 in display system 2 according to the embodiment.

As illustrated in FIG. 5, controller 8 includes vehicle direction estimator 42 (an example of an estimator), calculator 44, and drawer 46 as functional components.

Vehicle direction estimator 42 obtains, for example, (a) vehicle position information from navigation device 48 mounted on vehicle 4, (b) vehicle speed information from vehicle control device 50 mounted on vehicle 4, and (c) sensor information from gyroscope sensor 52 mounted on vehicle 4. Vehicle direction estimator 42 estimates the direction of vehicle 4 based on the obtained vehicle position information, vehicle speed information, and sensor information, and outputs vehicle direction information indicating the estimated direction of vehicle 4 to calculator 44. Here, the direction of vehicle 4 means the direction in the forward direction of vehicle 4.

Navigation device 48 is a device for guiding vehicle 4 to the destination using a satellite positioning system such as the Global Positioning System (GPS). Navigation device 48 outputs vehicle position information indicating the current location (current position) of vehicle 4 to vehicle direction estimator 42 and calculator 44. Navigation device 48 also outputs route information indicating route 22 from the current location of vehicle 4 to the destination, which is set on the navigation map, to calculator 44.

Vehicle control device 50 is, for example, an electronic control unit (ECU) mounted on vehicle 4, and outputs vehicle speed information indicating the traveling speed (vehicle speed) of vehicle 4 to vehicle direction estimator 42.

Gyroscope sensor 52 outputs sensor information indicating the yaw angle of vehicle 4 to vehicle direction estimator 42.

Calculator 44 obtains the route information and the vehicle position information from navigation device 48 and the vehicle direction information from vehicle direction estimator 42, and calculates the display direction of display image 12 based on the obtained route information, vehicle position information, and vehicle direction information. Specifically, calculator 44 calculates difference angle θ between the route direction at the current location of vehicle 4 on route 22 indicated by the route information (i.e. the direction of tangent 56 at route point 54 corresponding to the current location of vehicle 4 on route 22 in (a) in FIG. 4) and the direction of vehicle 4 indicated by the vehicle direction information. Calculator 44 then calculates the display direction of display image 12 based on comparison between calculated difference angle θ and threshold θ_{T} (for example, 2.0°).

In the case where difference angle θ is less than threshold θ_{T}, calculator 44 calculates a first direction along route 22 as the display direction of display image 12. Here, the first direction is the direction of tangent 60 at route point 58 located ahead of the current location of vehicle 4 on route 22, as illustrated in (a) in FIG. 4. The distance from the current location of vehicle 4 to route point 58 may be fixed (for example, several tens of meters), or may be variable depending on the road shape ahead (whether the road goes straight ahead or comes to an intersection that requires a right or left turn, etc.) and/or the traveling state (vehicle speed, etc.) of vehicle 4.

In the case where difference angle θ is greater than or equal to threshold θ_{T}, calculator 44 corrects the display direction of display image 12 from the first direction to a second direction in the direction of the yaw angle. Here, the second direction is a direction obtained by correcting the first direction by an angle (=θ−θ_{D}) that results from subtracting dead zone angle θ_{D} (for example, 2.0°) from difference angle θ. For example, when difference angle θ is 5.0°, threshold θ_{T} is 2.0° (<θ), and dead zone angle θ_{D} is 2.0°, the second direction is a direction obtained by correcting the first direction by an angle of 3.0° (=5.0°−2.0°). Calculator 44 determines dead zone angle θ_{D} to be larger when the number of lanes on the road on which vehicle 4 is traveling is larger, for example. This is because of the tendency that, when the number of lanes on the road is larger, route points vary more and the route direction error (i.e. the difference between the actual road direction and the below-described route direction) is greater. Moreover, given that route points tend to vary more at curves, forks, and junctions, calculator 44 may determine dead zone angle θ_{D} to be larger at curves, forks, and junctions. Alternatively, calculator 44 may determine dead zone angle θ_{D} to be smaller when the accuracy of the navigation map stored in navigation device 48 is higher, for example.

Drawer 46 draws display image 12 to be displayed on display panel 38 of display unit 28 based on the calculation result of calculator 44. Drawer 46 outputs image information indicating drawn display image 12 to display panel 38. Thus, display image 12 indicated by the image information from drawer 46 is displayed on display panel 38.

### [3. Operation of Controller]

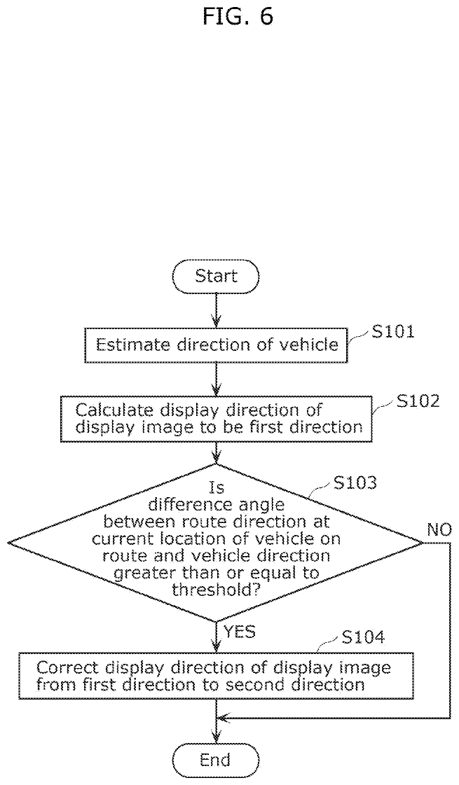

Next, the operation of controller 8 will be described with reference to FIGS. 4 and 6. FIG. 6 is a flowchart illustrating the flow of operation of controller 8 in display system 2 according to the embodiment.

It is assumed here that, at the start of the flowchart in FIG. 6, difference angle θ is less than threshold θ_{T} as vehicle 4 is traveling straight along route 22 as illustrated in (a) in FIG. 4, for example.

As illustrated in FIG. 6, first, vehicle direction estimator 42 estimates the direction of vehicle 4 based on vehicle position information from navigation device 48, vehicle speed information from vehicle control device 50, and sensor information from gyroscope sensor 52 (S101).

Next, calculator 44 calculates the display direction of display image 12 to be the first direction by calculating difference angle θ to be less than threshold θ_{T} based on route information and vehicle position information from navigation device 48 and vehicle direction information from vehicle direction estimator 42 (S102). Consequently, display 6 displays display image 12 pointing in the first direction as a virtual image, as illustrated in (b) in FIG. 4.

Calculator 44 then determines whether difference angle θ is greater than or equal to threshold θ_{T}. In the case where difference angle θ remains less than threshold θ_{T} (S103: NO), calculator 44 does not correct the display direction of display image 12 from the first direction. The process of the flowchart in FIG. 6 then ends.

In the case where difference angle θ is greater than or equal to threshold θ_{T} (S103: YES), calculator 44 corrects the display direction of display image 12 from the first direction to the second direction (S104). Consequently, display 6 displays display image 12 pointing in the second direction as a virtual image. The process of the flowchart in FIG. 6 then ends.

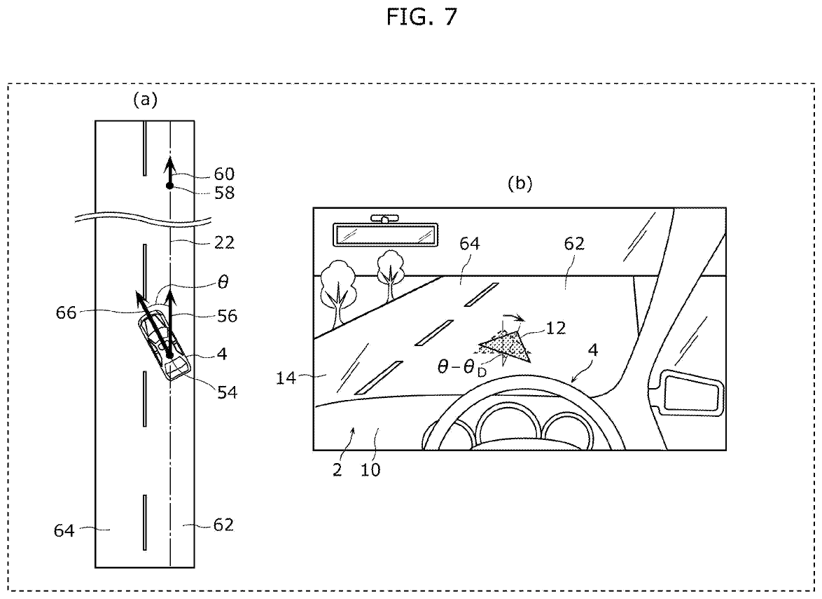

Specific examples of Step S104 in the flowchart in FIG. 6 will be described with reference to FIGS. 7 to 9. FIGS. 7 to 9 are each a diagram for explaining a specific example of Step S104 in the flowchart in FIG. 6.

In the example illustrated in (a) in FIG. 7, vehicle 4 that has been traveling straight in lane 62 is making a lane change to lane 64 adjacent to the left side of lane 62. At this time, as a result of the right and left front wheels of vehicle 4 being steered to the left, the direction of vehicle 4 changes from the direction along route 22 set on lane 62 to a direction inclined with respect to route 22.

Calculator 44 calculates difference angle θ between the route direction at the current location of vehicle 4 on route 22 indicated by the route information (i.e. the direction of tangent 56 at route point 54 corresponding to the current location of vehicle 4 on route 22 in (a) in FIG. 7) and the direction of vehicle 4 indicated by the vehicle direction information (i.e. the direction indicated by arrow 66 in (a) in FIG. 7). In the case where calculated difference angle θ is greater than or equal to threshold θ_{T}, calculator 44 corrects the display direction of display image 12 from the first direction to the second direction by angle θ−θ_{D} as illustrated in (b) in FIG. 7. The second direction is a direction obtained by correcting the first direction by angle θ−θ_{D}. Thus, the display direction of display image 12 can be corrected in a direction (yaw angle direction) approaching the direction along route 22.

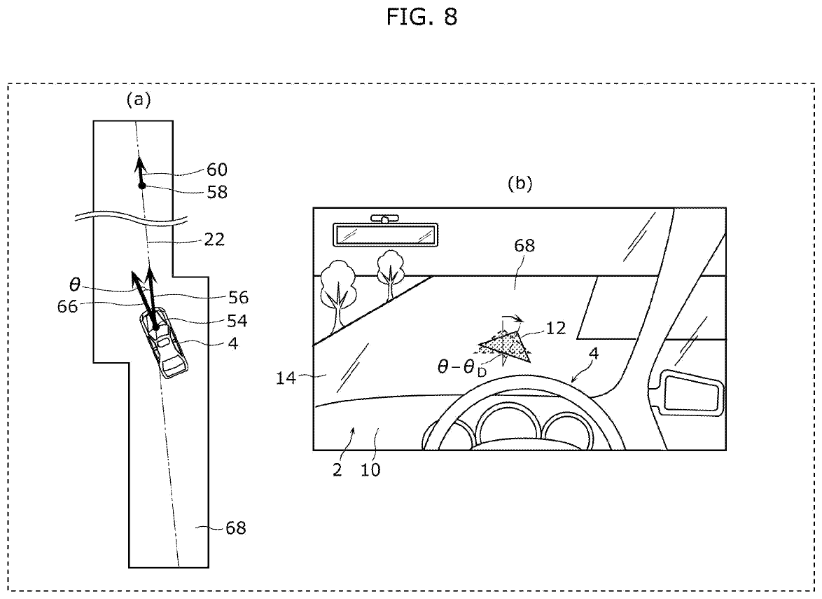

In the example illustrated in (a) in FIG. 8, vehicle 4 is traveling on crank 68. Crank 68 is a crank-shaped road in which two right-angled narrow curves are connected. At this time, as a result of the right and left front wheels of vehicle 4 being steered to the left, the direction of vehicle 4 changes from the direction along route 22 set on crank 68 to a direction inclined with respect to route 22.

Calculator 44 calculates difference angle θ between the route direction at the current location of vehicle 4 on route 22 indicated by the route information (i.e. the direction of tangent 56 at route point 54 corresponding to the current location of vehicle 4 on route 22 in (a) in FIG. 8) and the direction of vehicle 4 indicated by the vehicle direction information (i.e. the direction indicated by arrow 66 in (a) in FIG. 8). In the case where calculated difference angle θ is greater than or equal to threshold θ_{T}, calculator 44 corrects the display direction of display image 12 from the first direction to the second direction by angle θ−θ_{D} as illustrated in (b) in FIG. 8. The second direction is a direction obtained by correcting the first direction by angle θ−θ_{D}. Thus, the display direction of display image 12 can be corrected in a direction (yaw angle direction) approaching the direction along route 22.

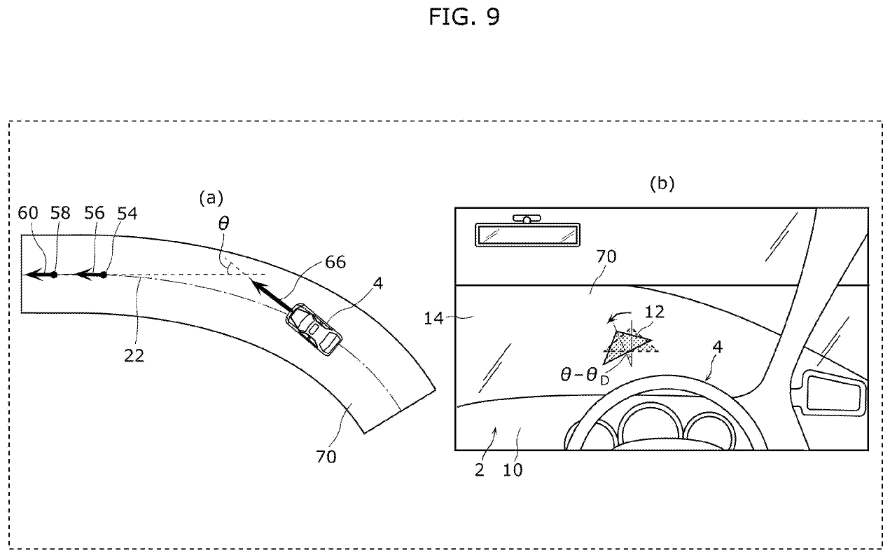

In the example illustrated in (a) in FIG. 9, vehicle 4 is traveling in the middle of sharp left curve 70 and is about to approach the exit of curve 70. At this time, as a result of the right and left front wheels of vehicle 4 being steered to the left, the direction of vehicle 4 changes from the direction along route 22 set on curve 70 to a direction inclined with respect to route 22.

Calculator 44 calculates difference angle θ between the route direction at the current location of vehicle 4 on route 22 indicated by the route information (i.e. the direction of tangent 56 at route point 54 corresponding to the current location of vehicle 4 on route 22 in (a) in FIG. 9) and the direction of vehicle 4 indicated by the vehicle direction information (i.e. the direction indicated by arrow 66 in (a) in FIG. 9). In the case where calculated difference angle θ is greater than or equal to threshold θ_{T}, calculator 44 corrects the display direction of display image 12 from the first direction to the second direction by angle θ−θ_{D} as illustrated in (b) in FIG. 9. The second direction is a direction obtained by correcting the first direction by angle θ−θ_{D}. Thus, even in the case where, due to an error in the vehicle position information obtained from navigation device 48, the current location of vehicle 4 on route 22 indicated by the vehicle position information is near the exit of curve 70 despite the current location of vehicle 4 being actually in the middle of curve 70, the display direction of display image 12 can be corrected in a direction (yaw angle direction) approaching the direction along route 22.

In the case where difference angle θ is greater than or equal to threshold θ_{T}, drawer 46 may change the display state of display image 12 between before and after the correction from the first direction to the second direction. The display state of display image 12 is, for example, at least one of the display position, orientation, color, density, shape, or lighting state of display image 12. For example, drawer 46 may change the color of display image 12 from green to yellow or change the lighting state of display image 12 from ON to blinking, between before and after the correction from the first direction to the second direction. For example, drawer 46 may change the display position of display image 12 in display area 16 right or left depending on the direction of the road on which vehicle 4 is traveling. Alternatively, drawer 46 may correct the first direction to the second direction while greatly rolling display image 12, or shift the horizontal display position of display image 12 in the same direction in which the first direction is corrected to the second direction.

### [4. Effects]

In the conventional display system described in the “Background” section, the display direction of display image 12 deviates from the direction along route 22 in situations such as when vehicle 4 is changing lanes, when vehicle 4 is traveling on crank 68, and when vehicle 4 is approaching the exit of curve 70.

In view of this, in this embodiment, display image 12 pointing in the first direction along route 22 is displayed as a virtual image in the case where difference angle θ is less than threshold θ_{T}, and display image 12 pointing in the second direction obtained by correcting the first direction is displayed as a virtual image in the case where difference angle θ is greater than or equal to threshold θ_{T}.

Thus, the display direction of display image 12 can be corrected in a direction approaching the direction along route 22 in situations such as when vehicle 4 is changing lanes, when vehicle 4 is traveling on crank 68, and when vehicle 4 is approaching the exit of curve 70. The accuracy of the display direction of display image 12 can therefore be enhanced.

Moreover, providing dead zone angle θ_{D} can suppress excessive correction (i.e. fluctuation of display image 12) due to a route direction error or a vehicle direction error (the difference between the actual direction of vehicle 4 and the direction of vehicle 4 indicated by the vehicle direction information).

### Other Variations

While a display system according to one or more aspects has been described above by way of the foregoing embodiment, the present disclosure is not limited to the foregoing embodiment. Other modifications obtained by applying various changes conceivable by a person skilled in the art to the foregoing embodiment and any combinations of the structural elements in different embodiments without departing from the scope of the present disclosure are also included in the scope of one or more aspects.

For example, although the display light from display 6 is reflected off display area 16 of windshield 14 in the foregoing embodiment, the present disclosure is not limited to such, and the display light from display 6 may be reflected off a combiner (an example of a display medium).

Although display 6 is implemented as a head-up display in the foregoing embodiment, at least one of vehicle direction estimator 42, calculator 44, or drawer 46 may also be implemented as part of the head-up display.

Each of the structural elements in the foregoing embodiment may be configured in the form of an exclusive hardware product, or may be implemented by executing a computer program suitable for the structural element. Each of the structural elements may be implemented by means of a program execution unit, such as a CPU and a processor, reading and executing the computer program recorded on a non-transitory recording medium such as a hard disk or semiconductor memory.

Part or all of the functions of controller 8 according to the foregoing embodiment may be implemented by a processor such as a CPU executing a computer program.

Part or all of the structural elements constituting each device may be configured as an IC card detachably mountable to the device or a standalone module. The IC card or the module is a computer system including a microprocessor, ROM, RAM, and so forth. The IC card or the module may include super-multifunctional LSI. The IC card or the module achieves its functions by the microprocessor operating according to a computer program. The IC card or the module may be tamper-resistant.

The present disclosure may be the control method according to the eighth aspect described above. The present disclosure may be a computer program that implements the control method by a computer, or may be digital signals including the computer program. The present disclosure may be the computer program or the digital signals recorded on a non-transitory computer-readable recording medium, such as flexible disk, hard disk, CD-ROM, MO, DVD, DVD-ROM, DVD-RAM, Blu-ray (registered trademark) disc (BD), or semiconductor memory. The present disclosure may also be the digital signals recorded on such a recording medium. The present disclosure may be the computer program or the digital signals transmitted over a network such as an electric communication line, a wireless or wired communication line, or the Internet, data broadcasting, or the like. The present disclosure may be a computer system including a microprocessor and memory, where the memory stores the computer program and the microprocessor operates according to the computer program. The present disclosure may also be carried out by another independent computer system, by the computer program or the digital signals being recorded on the recording medium and transferred, or by the computer program or the digital signals being transferred over the network or the like.

While an embodiment has been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2023-059079 filed on Mar. 31, 2023.

### INDUSTRIAL APPLICABILITY

The present disclosure is applicable to, for example, a display system used for a head-up display mounted on a vehicle.

1. A display system used for a head-up display provided to a vehicle, the display system comprising:
a drawer that draws a display image for guiding the vehicle to a destination;
a display that projects light representing the display image to a display medium of the vehicle, to display the display image as a virtual image through the display medium; and
an estimator that estimates a direction of the vehicle,
wherein when a difference angle between a route direction at a current location of the vehicle on a route that is set for guiding the vehicle to the destination and the direction of the vehicle estimated is less than a threshold, the display displays the display image pointing in a first direction along the route as the virtual image, and when the difference angle is greater than or equal to the threshold, the display displays the display image pointing in a second direction obtained by correcting the first direction as the virtual image.

2. The display system according to claim 1,
wherein the second direction is obtained by correcting the first direction by an angle that results from subtracting a dead zone angle from the difference angle.

3. The display system according to claim 2,
wherein the dead zone angle is determined to be larger when a total number of lanes on a road on which the vehicle is traveling is larger.

4. The display system according to claim 2,
wherein the route is a route on a navigation map, and
the dead zone angle is determined to be smaller when the navigation map has higher accuracy.

5. The display system according to claim 1,
wherein when the difference angle is greater than or equal to the threshold, the drawer changes a display state of the display image between before and after the first direction is corrected to the second direction.

6. The display system according to claim 1,
wherein the route direction at the current location of the vehicle is a direction of a tangent at a route point corresponding to the current location of the vehicle on the route, and
the first direction is a direction of a tangent at a route point located ahead of the current location of the vehicle on the route.

7. A control method in a display system used for a head-up display provided to a vehicle, the control method comprising:
(a) drawing a display image for guiding the vehicle to a destination;
(b) projecting light representing the display image to a display medium of the vehicle, to display the display image as a virtual image through the display medium; and
(c) estimating a direction of the vehicle,
wherein in (b), when a difference angle between a route direction at a current location of the vehicle on a route that is set for guiding the vehicle to the destination and the direction of the vehicle estimated is less than a threshold, the display image pointing in a first direction along the route is displayed as the virtual image, and when the difference angle is greater than or equal to the threshold, the display image pointing in a second direction obtained by correcting the first direction is displayed as the virtual image.
